(19) United States
(12) Patent Application Publication
(10) Pub. No.: US 2023/0243112 A1
(43) Pub. Date: Aug. 3, 2023

(54) ROAD MAKING MACHINE WITH PHOTOVOLTAIC SYSTEM

(71) Applicant: JOSEPH VOEGELE AG, Ludwigshafen/Rhein (DE)

(72) Inventor: Nicole ANGERMANN, Bruehl (DE)

(73) Assignee: JOSEPH VOEGELE AG, Ludwigshafen/Rhein (DE)

(21) Appl. No.: 18/103,544

(22) Filed: Jan. 31, 2023

(30) Foreign Application Priority Data
Jan. 31, 2022 (EP) 22154287.1

(51) Int. Cl. E01C 19/48; B60L 8/00

(52) U.S. Cl. CPC E01C 19/4873; B60L 8/003; E01C 2301/04; E01C 2301/16; E01C 2301/30

(57) ABSTRACT

The disclosure relates to a road making machine in the form of a road finishing machine or a charger vehicle for conveying laying material to a road finishing machine. The road making machine is self-propelled and comprises a travel drive, a material bunker, a driver stand, and a photovoltaic system. The photovoltaic system includes at least one photovoltaic module for generating electric current, a power storage system, and a charge controller.

### CROSS-REFERENCE TO RELATED APPLICATIONS

This application claims foreign priority benefits under 35 U.S.C. § 119(a)-(d) to European patent application number EP 22154287.1, filed Jan. 31, 2022, which is incorporated by reference in its entirety.

### TECHNICAL FIELD

The present disclosure relates to a road making machine in the form of a road finishing machine or a charger vehicle for a road finishing machine.

### BACKGROUND

Road finishing machines are employed for applying a pavement of mixed laying material, for example of concrete, bituminous mixed laying material, or asphalt, onto a place, a path, or a road. Such a road finishing machine usually has a material bunker to store a certain amount of mixed laying material. If the storage capacity is to be increased, a charger is placed in front of the road finishing machine in the working direction. This charger comprises a further material bunker as well as a conveyor means for transporting laying material from the charger’s material bunker into the material bunker of the road finishing machine.

The road making machines have a considerable energy consumption. The power grid in the conventional road making machines with an internal combustion engine is usually supplied by a generator that is driven with expensive fossil energy carriers. Consequently, it is desired to reduce the operating costs of the road making machine.

Motor vehicles with solar modules are known, for example, from EP 1 110 779 A2, and EP 0 685 363 A1.

### SUMMARY

It is an object of the disclosure to provide a road making machine in the form of a road finishing machine or a charger vehicle for a road finishing machine that can be operated at low costs.

The road making machine according to the disclosure is provided in the form of a road finishing machine or a charger vehicle for conveying laying material to a road finishing machine, wherein the road making machine is self-propelled and comprises a travel drive, a material bunker, and a driver stand, wherein the road making machine comprises a photovoltaic system, wherein the photovoltaic system comprises at least one photovoltaic module for generating electric current, a power storage system, and a charge controller.

An advantage of the road making machine according to the disclosure is the reduction of energy costs by obtaining the energy from a photovoltaic system. Another advantage is the reduction of environmental pollution since less CO₂ emissions are produced. Another advantage is that the electric consumers can be supplied off-grid when the road making machine is switched off.

The photovoltaic system can be a technical system for converting solar energy into electric energy or solar power. The photovoltaic system can generate, e.g., 500 kWh to 2,000 kWh of solar power per year. The width of a photovoltaic module can be, e.g., 100 mm to 1000 mm. The length of a photovoltaic module can be, e.g., 200 mm to 2000 mm. The photovoltaic system can include at least one voltage converter. A photovoltaic module can include, e.g., 10 to 100 solar cells. The photovoltaic module can be stiff so that it cannot be bent. The photovoltaic module can be bendable, so that it can be bent. The photovoltaic module can include at least one protective layer. The photovoltaic module can be attached between two plates or protective layers. The protective layer can be a glass layer, e.g., tempered glass (ESG), or a transparent plastic layer of ethylene vinyl acetate (EVA). The photovoltaic module can be frameless. The photovoltaic module can include a frame which facilitates assembly. The photovoltaic module can include a stiff rack. The adjacent photovoltaic modules can be connected with each other by fastening means. The adjacent photovoltaic modules can be shifted into each other via a groove-spring connection. The photovoltaic module can be engaged on the road making machine by fastening means and/or a pillar system. The photovoltaic module can include at least one electrical outlet. The photovoltaic module can include at least one cabling. A charge controller and an accumulator can be integrated in the photovoltaic module. A voltage converter can be integrated in the photovoltaic module.

The road making machine can be an asphalt miller or a roller.

The photovoltaic modules can be releasably or non-releasably fixed to a portion of the road making machine. The non-releasable fastening of the photovoltaic modules can be realized by welded joints, solder joints, adhesive joints, rivet joints, or press-fits and shrink fits. A portion of the road making machine can be partially or completely replaced by the photovoltaic module.

In one advantageous embodiment, a driver roof with a main roof body is arranged at the driver stand, wherein a photovoltaic module of the photovoltaic system is fastened to the main roof body, preferably in a releasable manner, or the main roof body is at least partially embodied by a photovoltaic module of the photovoltaic system. The driver roof can provide an optimal photovoltaic module surface for sunlight that is incident perpendicularly. By a releasable attachment of the photovoltaic module, the photovoltaic module can be easily replaced or completely deinstalled again. The integration of the photovoltaic module into the main roof body or the replacement of the main roof body can permit a protection against theft. Furthermore, this can make the main roof body tighter and more compact which in turn permits a better weathering protection. At least one of the photovoltaic modules of the photovoltaic system can be non-releasably fastened to the driver roof. A non-releasable fastening of the photovoltaic modules can be realized by welded joints, solder joints, adhesive joints, rivet joints, or press-fits and shrink fits.

In one advantageous embodiment, the driver roof includes an extension module, wherein the extension module is arranged at the main roof body to be movable from a storage position to an extension position, preferably shiftable and/or rotatable relative to the main roof body, wherein a photovoltaic module of the photovoltaic system is fastened to the extension body, preferably in a releasable manner, or the extension module is at least partially embodied by a photovoltaic module of the photovoltaic system. Thereby, a width of the driver roof can be extended transverse to a direction of travel, and/or a length of the component can be extended along a direction of travel. Thereby, a large area for protection against sun and rain can be provided for the road construction worker. Furthermore, by the extension of the driver roof, more electric current can be generated since the main module and the extension module each include a photovoltaic module. The photovoltaic modules can be protected from external conditions in the storage position. The width of the component and/or the length of the component can be extended essentially horizontally. The width of the component and/or the length of the component can be extended, e.g., by two times or by approximately five times. Extension modules can be attached to the main module by means of screws, connecting terminals, clamps, knuckles, articulated arms, belts, racks, or rails. Extension modules can be arranged underneath and/or above the main body roof. The extension module can be an awning. By a releasable attachment of the photovoltaic module, the photovoltaic module can be easily replaced or completely deinstalled again. The integration of the photovoltaic module into the extension module or the replacement of the extension module can permit a protection against theft.

In one advantageous embodiment, a photovoltaic module of the photovoltaic system is fastened to an external wall of a material bunker, preferably in a releasable manner. Thereby, the covering surface of the road making machine can be optimally used for obtaining the electric energy. By a releasable attachment of the photovoltaic module, the photovoltaic module can be easily replaced or completely deinstalled again. At least one of the photovoltaic modules of the photovoltaic system can be non-releasably fastened to the material bunker. A non-releasable fastening of the photovoltaic modules can be realized by welded joints, solder joints, adhesive joints, rivet joints, or press-fits and shrink fits.

In one advantageous embodiment, a photovoltaic module of the photovoltaic system is fastened to an external wall of an engine cowling, preferably in a releasable manner. Thereby, the cover of the road making machine can be optimally used for obtaining the electric energy. By a releasable attachment of the photovoltaic module, the photovoltaic module can be easily replaced or completely deinstalled again. At least one of the photovoltaic modules of the photovoltaic system can be non-releasably fastened to the engine cowling. The non-releasable fastening of the photovoltaic modules can be realized by welded joints, solder joints, adhesive joints, rivet joints, or press-fits and shrink fits.

In one advantageous embodiment, the road making machine is embodied in the form of the road finishing machine and has a screed, wherein a photovoltaic module of the photovoltaic system is fastened to a basic screed body of the screed, preferably in a releasable manner. Thereby, the covers of the road making machine can be optimally used for obtaining the electric energy. By a releasable attachment of the photovoltaic module, the photovoltaic module can be easily replaced or completely deinstalled again. At least one of the photovoltaic modules of the photovoltaic system can be non-releasably fastened to the screed. The non-releasable fastening of the photovoltaic modules can be realized by welded joints, solder joints, adhesive joints, rivet joints, or press-fits and shrink fits.

In one advantageous embodiment, a photovoltaic module of the photovoltaic system is fastened to at least one pull-out part arranged at the basic screed body to be shiftable from a storage position to an extension position. Thereby, the photovoltaic system can have a larger area for generating electric current in the extension position. The photovoltaic modules can be protected from external conditions in the storage position.

In one advantageous embodiment, a photovoltaic module of the photovoltaic system is fastened to at least one screed extension body that is fastened to the basic screed body or the pull-out part, preferably in a releasable manner. Thereby, the photovoltaic system can have a larger area for generating electric current.

In one advantageous embodiment, the photovoltaic module is a removable foil. The foil can be glued on during the road making operation. The foil can be removed after the road making operation or for maintenance or cleaning works.

In one advantageous embodiment, the photovoltaic module comprises a foil non-releasably fastened to the road making machine. The non-releasable fastening of the photovoltaic modules can be realized by welded joints, solder joints, adhesive joints, rivet joints, or press-fits and shrink fits.

In one advantageous embodiment, at least one electric consumer and/or a power grid of a road finishing machine is configured to be supplied with electric current generated by the road making machine in the form of a charger vehicle. The electric consumer can be a cooling system. The cooling system can be utilized for cooling a battery or other electric consumers. The electric consumer can be a battery. The electric consumer can be a heating unit. The heating unit can be used for a screed heating of the road finishing machine. The electric consumer can be an operating panel. The electric consumer can be a projector of the road finishing machine which is designed to project at least one process parameter set at the operating panel and/or displayed at the display onto at least one projected area. The electric consumer can be a GPS unit. The electric consumer can be a telematic terminal for a telematic system. The telematic system can record information with respect to position, speed, fuel consumption and engine efficiency 24 hours on seven days. Even if the road making machine is standing still for a relatively long period when a vehicle battery is empty, the telematic terminal can function by being supplied with solar power. The electric consumer can be a light. The light can be a light marking for the night construction operation to show the workers the access region of the road making machine or to show them where they must not step on. The electric consumer can be a mobile unit. By the feeding with solar power, the electric consumers can function without any additional battery or supply from a vehicle battery or generator of the road finishing machine.

In one advantageous embodiment, at least one electric consumer and/or a power grid of a charger vehicle is configured to be supplied with electric current generated by the road making machine in the form of the road finishing machine. The electric consumer can be a cooling system. The cooling system can be utilized for cooling a battery or other electric consumers. The electric consumer can be a battery. The electric consumer can be a heating unit. The heating unit can be used for a heating of the material bunker of the road finishing machine. The heating unit can be used for the heating of a conveying system of the road making machine. The electric consumer can be a GPS unit. The electric consumer can be a telematic terminal for a telematic system. The telematic system can record information with respect to position, speed, fuel consumption and engine efficiency 24 hours on seven days. Even if the road making machine is standing still for a relatively long period when a vehicle battery is empty, the telematic terminal can function by being supplied with solar power. The electric consumer can be a light. The light can be a light marking for the night construction operation to show the workers the access region of the road making machine or to show them where they must not step on. The electric consumer can be a mobile unit. By the feeding with solar power, the electric consumers can function without any additional battery or supply from a vehicle battery or generator of the road finishing machine.

In one advantageous embodiment, at least one of the photovoltaic modules of the photovoltaic system is arranged to be rotatable and/or shiftable relative to a portion of the road making machine. In one advantageous embodiment, at least one of the photovoltaic modules of the photovoltaic system is arranged to be tiltable relative to a portion of the road making machine. Thereby, the inclinations of the photovoltaic module with respect to the portion of the road making machine can be optimally set for obtaining the electric energy.

### BRIEF DESCRIPTION OF THE DRAWINGS

Below, exemplary embodiments will be illustrated with reference to the figures.

FIG. 1 shows a schematic perspective view of a road making machine in the form of a road finishing machine with a photovoltaic system;

FIG. 2 shows a schematic perspective view of the road finishing machine;

FIG. 3 shows a schematic partial plan view of a screed of the road finishing machine;

FIG. 4 shows a schematic partial plan view of the screed of the road finishing machine;

FIG. 5 shows a schematic perspective view of a road making machine in the form of a charger vehicle with a photovoltaic system; and

FIG. 6 shows a schematic perspective view of the charger vehicle.

### DETAILED DESCRIPTION

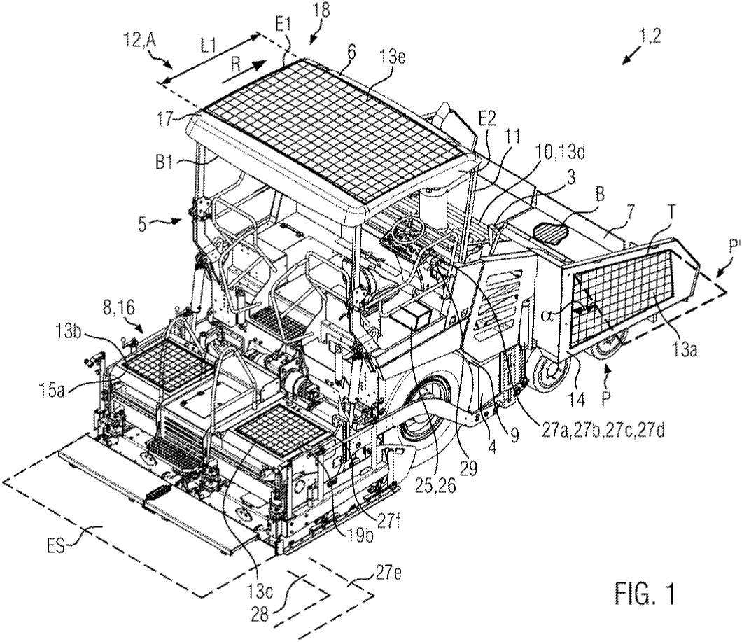

FIG. 1 shows, in a perspective view from obliquely behind, a road making machine 1 which is a road finishing machine 2 for producing a paving layer ES. The road finishing machine 2 is self-propelled. The road finishing machine 2 has a travel drive 3 (e.g., an internal combustion engine, an electric motor, a hydrogen engine, or a hybrid motor), a chassis 4, a driver stand 5, a driver roof 6, working units, such as a material bunker 7 for receiving a laying material B, a screed 8 mounted at the chassis 4 to be height adjustable and being towed in the direction of travel R, a conveyor unit 9 to provide the laying material B from a material bunker 7 of the road finishing machine 2 to the screed 8. The road finishing machine 2 comprises further components as well as an engine compartment cowling 10. The driver roof 6 spans the driver stand 5 which is supported by a pillar structure 11. The pillar structure 11 can be foldable.

The road finishing machine 2 has a photovoltaic system 12 with several photovoltaic modules 13. In one embodiment, a first photovoltaic module 13a is fastened to a first external wall 14 of the material bunker 7. In one embodiment, the photovoltaic module 13a can be attached to a fastening component T to be rotatable from a first position P to a second position P′ to orient an angle of inclination α of the photovoltaic module 13a towards the sun. On a second external wall (not shown), too, a photovoltaic module (not shown) can be fastened.

A second and a third photovoltaic module 13b, 13c are fastened on two cover plates 15a, 15b of a basic screed body 16 of the screed 8. A fourth photovoltaic module 13d is attached to the engine compartment cowling 10. In a non-depicted embodiment, an angle of inclination α of the photovoltaic modules 13b, 13c, 13d can also be adjustable.

A fifth photovoltaic module 13e is fastened on a main roof body 17 of the driver roof 6. In this embodiment, the main roof body 17 is a plastic plate. It is also possible to completely replace the main roof body 17 by the fifth photovoltaic module 13e and to directly fix the fifth photovoltaic module 13e to the pillar structure 11.

The driver roof 6 has a first width B1 and/or a first length L1. The first width B1 and/or a first length L1 of the driver roof 6 can be extended to provide a larger protecting area against sun and rain for the operator and simultaneously extend a first cover surface A of the photovoltaic system 12 (the cover surface A corresponds to a total erected photovoltaic module surface of the photovoltaic system 12 visible from outside). To this end, the driver roof 6 has two extension modules E1, E2 arranged at the main roof body 17 to be laterally extendable, for example awnings. In FIG. 1, the extension modules E1, E2 are in their storage positions 18 where they are stored under the main roof body 17.

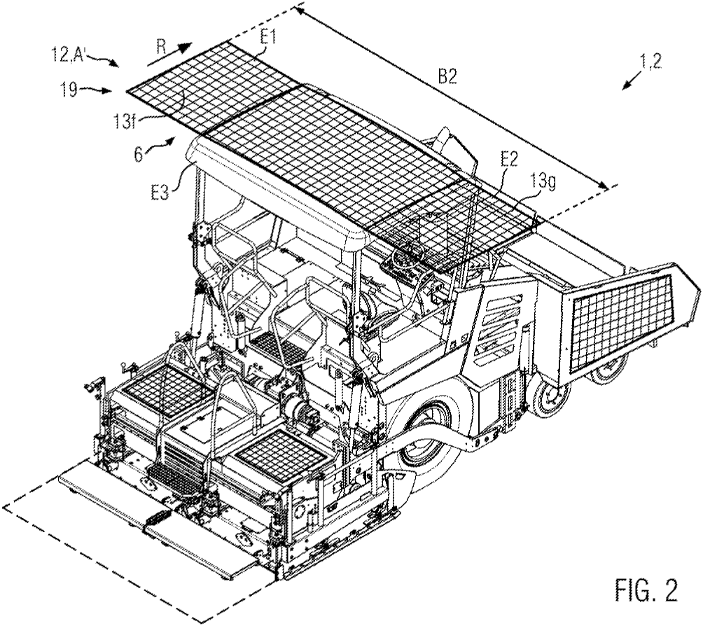

FIG. 2 shows the extension modules E1, E2 of the driver roof 6 in an extension position 19. Here, the driver roof 6 has a second width B2 which is larger than the first width B1. The extension module E1 has a sixth photovoltaic module 13f. The extension module E2 has a seventh photovoltaic module 13g. The photovoltaic system 12 has an extended cover surface A′ when the extension modules E1, E2 are in their extension positions 19. In the storage position 18, the photovoltaic modules 13f, 13g are protected from external conditions.

A first length L1 of the driver roof 6 can be extended along the direction of travel R, e.g., by an extension module E3 arranged to be extendable along the direction of travel R and comprising a photovoltaic module 13.

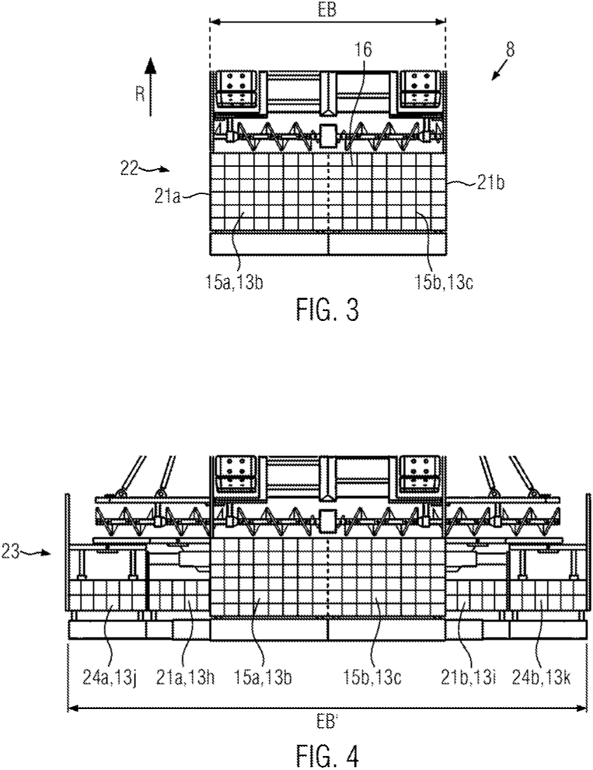

FIG. 3 shows an embodiment of the screed 8, wherein two pull-out parts 21a, 21b arranged to be movable laterally at the basic screed body 16 are in their storage positions 22. The second and third photovoltaic modules 13b, 13c are fastened on two cover plates 15a, 15b of a basic screed body 16 of the screed 8. A laying width EB of the screed 8 can be varied in a direction transverse to the direction of travel R of the road finishing machine 2 to be able to achieve different laying widths. To this end, the pull-out parts 21a, 21b can be extended from their storage positions 22 to an extension position 23.

FIG. 4 shows the pull-out parts 21a, 21b extended in their extension positions 23 transverse to the direction of travel R. The pull-out parts 21a, 21b have photovoltaic modules 13h, 13i which are exposed to the sun in the extension position 23 of the pull-out parts 21a, 21b to generate electric current S. In the storage position 22, the photovoltaic modules 13h, 13i are protected from external conditions.

In order to further enlarge the laying width EB′ of the screed 8, screed extension bodies 24a, 24b can be fastened to the pull-out parts 21a, 21b. The screed extension bodies 24a, 24b can also have photovoltaic modules 13j, 13k.

The photovoltaic system 12 includes a power storage system 25 (cf. FIG. 1). The photovoltaic system 12 furthermore includes a charge controller 26 to protect the power storage system 25 from overcharging. The photovoltaic modules 13a-k can be connected to the charge controller 26 via cabling (not shown), the charge controller being connected to the power storage system 25.

The road finishing machine 2 can have a plurality of electric consumers 27 which are supplied with electric current S generated by the photovoltaic system 12. An electric consumer 27 can be a telematic module 27a. An electric consumer 27 can be a global positioning system (GPS) unit 27b. An electric consumer EV can be a cooling system 27c for cooling a vehicle battery 27d. An electric consumer 27 can be a light 27e, in particular for illuminating the access area 28 of the road finishing machine 2 on the night construction sites. An electric consumer 27 can be a heating unit 27f. The heating unit 27f can be used for heating the screed 8. The electric current S obtained from the photovoltaic system 12 can be fed into a power grid 29 of the road finishing machine 2.

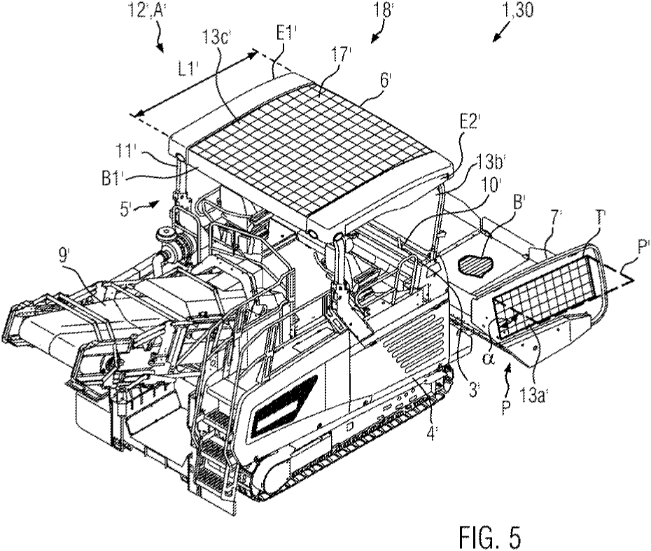

FIG. 5 shows, in a perspective view from obliquely behind, a road making machine 1 which is a charger vehicle for a road finishing machine 2. The charger vehicle 30 is self-propelled and comprises a travel drive 3′ (e.g., an internal combustion engine, an electric motor, a hydrogen engine, or a hybrid motor), a chassis 4′, a driver stand 5′, a driver roof 6′, working units, such as a material bunker 7′ for receiving a laying material B′, and a conveyor unit 9′ for transporting the laying material B′ from the material bunker 7′ of the charger vehicle 30 into the material bunker 7 of the road finishing machine 2. The charger vehicle 30 comprises an engine compartment cowling 10′. The driver roof 6′ spans the driver stand 5′ which is supported by a pillar structure 11′. The pillar structure 11′ can be foldable.

The charger vehicle 30 has a photovoltaic system 12′ with several photovoltaic modules 13′. In one embodiment, a first photovoltaic module 13a′ is fastened to a first external wall 14′ of the material bunker 7′. In one embodiment, the photovoltaic module 13a′ can be attached to a fastening component T′ to be rotatable from a first position P′ to a second position P′ to orient an angle of inclination α′ of the photovoltaic module 13a′ towards the sun. On a second external wall (not shown), too, a photovoltaic module (not shown) can be fastened. A second photovoltaic module 13b′ is attached to the engine compartment cowling 10′. In a non-depicted embodiment, an angle of inclination α of the photovoltaic module 13b′ can also be adjustable.

A third photovoltaic module 13c′ is fastened on a main roof body 17 of the driver roof 6′. In this embodiment, the main roof body 17′ is a plastic plate. It is also possible to completely replace the main roof body 17′ by the third photovoltaic module 13c′ and to directly fix the third photovoltaic module 13c′ to the pillar structure 11′.

The driver roof 6′ has a first width B1′ and/or a first length L1′. The first width B1′ and/or a first length L1′ of the driver roof 6′ can be extended to provide a larger protecting area against sun and rain for the operator and simultaneously extend a first cover surface A″ of the photovoltaic system 12 (the cover surface A″ corresponds to a total erected photovoltaic module area of the photovoltaic system 12′ visible from outside). To this end, the driver roof 6′ has two extension modules E1′, E2′ arranged at the main roof body 17′ to be laterally extendable, for example awnings. In FIG. 5, the extension modules E1′, E2′ are in their storage positions 18′ where they are stored under the main roof body 17′.

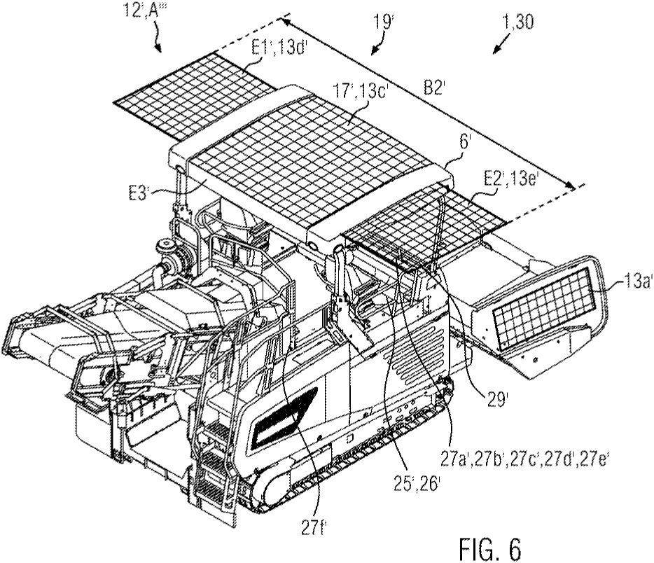

FIG. 6 shows the extension modules E1′, E2′ of the driver roof 6′ in an extension position 19′. The extension module E1′ has a fourth photovoltaic module 13d′. The extension module E2′ has a fifth photovoltaic module 13e′.

Here, the driver roof 6′ has a second width B2′ which is larger than the first width B1′. The photovoltaic system 12′ has an extended cover surface A‴ when the extension modules E1, E2 are in their extension positions 19′. In the storage position 18, the photovoltaic modules 13d′, 13e′ are protected from external conditions.

A first length L1′ of the driver roof 6′ can be extended along a direction of travel R′, e.g., by an extension module E3′ arranged to be extendable along the direction of travel R′ and comprising a photovoltaic module.

The photovoltaic system 12′ has a power storage system 25′. The photovoltaic system 12′ furthermore includes a charge controller 26′ to protect the power storage system 25′ from overcharging. The photovoltaic modules 13a-e′ can be connected to the charge controller 26′ via cabling (not shown), the charge controller being connected to the power storage system 25′.

The charger vehicle 30 can have a plurality of electric consumers 27′ which are supplied with electric current S′ generated by the photovoltaic system 12′. An electric consumer 27′ can be a telematic module 27a′. An electric consumer 27′ can be a global positioning system (GPS) unit 27b′. An electric consumer 27′ can be a cooling system 27c′ for cooling a vehicle battery 27d′. An electric consumer 27′ can be a light 27e′, in particular for illuminating the access area 28 of the road finishing machine 30 on the night construction sites. An electric consumer 27′ can be a heating unit 27f. The heating unit 27f can be used for heating the material bunker 7′ or conveyor unit 9′. The electric current S′ obtained from the photovoltaic system 12′ can be fed into a power grid 29′ of the charger vehicle 30.

It is also possible that during a road construction operation, the charger vehicle 30 is positioned in front of the road finishing machine 2 in the direction of travel R′ to transport laying material B′ from the material bunker 7′ of the charger vehicle 30 into the material bunker 7 of the road finishing machine 2. In the process, the electric current S′ obtained from the photovoltaic system 12′ of the charger vehicle 30 can be fed into a power grid 29 of the road finishing 2, or the electric current S obtained from the photovoltaic system 12 of the road finishing machine 2 can be fed into a power grid 29′ of the charger vehicle 30.

As those skilled in the art will understand, the power storage system 25, the power storage system 25′, the charge controller 26, the charge controller 26′, as well as any other controller, module, unit, component, system, subsystem, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC) or Electronic Control Unit (ECU), or several processors and various circuitry and/or hardware may be distributed among several separate components, whether individually packaged or assembled into a System-on-a-Chip (SoC). The power storage system 25 and the power storage system 25′ may each also include one or more batteries and/or any other type of electrical power storage device (e.g., capacitor).

What is claimed is:

1. A road making machine formed as a road finishing machine or a charger vehicle for conveying laying material to a road finishing machine, wherein the road making machine is self-propelled and comprises a travel drive, a material bunker, a driver stand, and a photovoltaic system, wherein the photovoltaic system includes at least one photovoltaic module for generating electric current, a power storage system, and a charge controller.

2. The road making machine according to claim 1, further comprising a driver roof with a main roof body arranged at the driver stand, wherein the at least one photovoltaic module comprises a first photovoltaic module fastened to the main roof body.

3. The road making machine according to claim 2, wherein the first photovoltaic module is fastened to the main roof body in a releasable manner.

4. The road making machine according to claim 2, wherein the driver roof includes an extension module arranged at the main roof body to be shiftable and/or rotatable from a storage position to an extension position, wherein the at least one photovoltaic module comprises a second photovoltaic module, and the second photovoltaic module is fastened to the extension module or the extension module is at least partially embodied by the second photovoltaic module.

5. The road making machine according to claim 4, wherein the second photovoltaic module is fastened to the extension module in a releasable manner.

6. The road making machine according to claim 1, further comprising a driver roof with a main roof body arranged at the driver stand, wherein the at least one photovoltaic module comprises a first photovoltaic module, and the main roof body is at least partially embodied by the first photovoltaic module.

7. The road making machine according to claim 6, wherein the at least one photovoltaic module comprises a second photovoltaic module, the driver roof includes an extension module arranged at the main roof body to be shiftable and/or rotatable from a storage position to an extension position, and the second photovoltaic module is fastened to the extension module or the extension module is at least partially embodied by the second photovoltaic module.

8. The road making machine according to claim 1, wherein the at least one photovoltaic module comprises a photovoltaic module fastened to an external wall of the material bunker.

9. The road making machine according to claim 1, further comprising an engine cowling, wherein the at least one photovoltaic module comprises a photovoltaic module fastened to the engine cowling.

10. The road making machine according to claim 1, wherein the road making machine is embodied as the road finishing machine and includes a screed comprising a basic screed body, and wherein the at least one photovoltaic module comprises a first photovoltaic module fastened to the basic screed body of the screed.

11. The road making machine according to claim 10, wherein the first photovoltaic module is fastened to the basic screed body of the screed in a releasable manner.

12. The road making machine according to claim 10, wherein the screed comprises a pull-out part arranged at the basic screed body to be shiftable from a storage position to an extension position, and wherein the at least one photovoltaic module comprises a second photovoltaic module fastened to the pull-out part.

13. The road making machine according to claim 10, wherein the screed comprises at least one screed extension body arranged at the basic screed body, and wherein the at least one photovoltaic module comprises a second photovoltaic module fastened to the at least one screed extension body.

14. The road making machine according to claim 10, wherein the screed comprises a pull-out part arranged at the basic screed body, and a screed extension body arranged at the pull-out part, and wherein the at least one photovoltaic module comprises a second photovoltaic module fastened to the screed extension body.

15. The road making machine according to claim 1, wherein the road making machine is embodied as the charger vehicle, and the charger vehicle is configured to feed electric current obtained from the photovoltaic system to a power grid and/or at least one electric consumer of a road finishing machine.

16. The road making machine according to claim 1, wherein the road making machine is embodied as the road finishing machine, and the road finishing machine is configured to feed electric current obtained from the photovoltaic system to a power grid and/or at least one electric consumer of a charger vehicle.

17. The road making machine according to claim 1, wherein the at least one photovoltaic module comprises a photovoltaic module arranged to be rotatable and/or shiftable relative to a portion of the road making machine.

18. A road making machine formed as a road finishing machine or a charger vehicle for conveying laying material to a road finishing machine, wherein the road making machine is self-propelled and comprises an electric consumer and a photovoltaic system configured to generate electric current for use by the electric consumer, wherein the photovoltaic system includes at least one photovoltaic module, a power storage system associated with the at least one photovoltaic module, and a charge controller connected to the power storage system.
